(19) United States
(12) Patent Application Publication
(10) Pub. No.: US 2022/0353524 A1
(43) Pub. Date: Nov. 3, 2022

(54) Parallel forensic marking apparatus and method

(71) Applicant: WOOKYOUNG INFORMATION TECHNOLOGY CO., LTD., Daegu (KR)

(72) Inventors: Yun-Ha Park, Daegu (KR); Dae-Soo Kim, Daegu (KR); Jae-Hyun Jun, Daegu (KR)

(21) Appl. No.: 17/256,828

(22) PCT Filed: Nov. 26, 2020
(86) PCT No.: PCT/KR2020/016997

§ 371 Date: Dec. 29, 2020

(30) Foreign Application Priority Data
Nov. 28, 2019 (KR) 10-2019-0155718

(51) Int. Cl. H04N 19/467; H04N 19/91; H04N 19/60; H04N 19/167; H04N 19/423; H04N 19/172; H04N 19/119; H04N 19/436

(52) U.S. Cl. CPC H04N 19/467; H04N 19/91; H04N 19/60; H04N 19/167; H04N 19/423; H04N 19/172; H04N 19/119; H04N 19/436

(57) ABSTRACT

Provided is a parallel forensic marking apparatus. The forensic marking apparatus may include a split part configured to split one frame of content, compressed using a setting method, into a plurality of regions, a plurality of decoding parts configured to have the split regions assigned thereto, respectively, and to perform entropy-decode the split regions, and a synchronization part configured to complete the frame by synchronizing the regions input to and output from the plurality of decoding parts.

### BACKGROUND OF THE DISCLOSURE

### Field of the Disclosure

The present invention relates to a forensic marking apparatus and method for inserting a forensic mark into compressed content.

### Related Art

A forensic marking technique is a technique for inserting information on a seller, a copyright proprietor or a buyer into multimedia content, and is a technique for identifying a disseminator by extracting inserted information (forensic mark) when content is illegally distributed.

For example, if buyer information is inserted into content using a forensic marking technique when an online service provider (OSP) provides the content, when an illegal leakage problem occurs in the corresponding content in the future, the first disseminator may be held liable for the leaked content by identifying a forensic mark.

A process of inserting a forensic mark into multimedia content requires a lot of computational load and time because steps of inserting the forensic mark and coding the forensic mark again are performed after the corresponding content is decoded.

That is, when multiple service requests are simultaneously received from a server that provide real-time download and streaming services for content, such as digital audio sources and video, there is a problem in that forensic marking processing for each piece of content that require a lot of computational load and time as described above causes a heavy load on the server.

### SUMMARY

An object of the present invention is to provide a forensic marking apparatus and method capable of inserting a forensic mark into a compressed content file in real time.

A forensic marking apparatus of the present disclosure may include a first unit configured to decode content compressed using a set method; a marking unit configured to insert a forensic mark into the content decoded by the first unit; a second unit configured to encode the content into which the forensic mark has been inserted; and a transform unit configured to synchronize a first input and output format between the first unit and the marking unit or synchronize a second input and output format between the second unit and the marking unit.

A forensic marking apparatus of the present disclosure may include may include a split part configured to split one frame of content, compressed using a setting method, into a plurality of regions; a plurality of decoding parts configured to have the split regions assigned thereto, respectively, and to perform entropy-decode the split regions; and a synchronization part configured to complete the frame by synchronizing the regions input to and output from the plurality of decoding parts.

A forensic marking method of the present disclosure may include a parsing step of identifying a first input and output format between entropy decoding and an insertion operation of a forensic mark and a second input and output format between the insertion operation and entropy encoding by pre-decoding content compressed using a set method; a decoding step of entropy-decoding the content and transforming the entropy-decoded content according to the first input and output format; a marking step of receiving the content transformed into the first input and output format and inserting a forensic mark into the content; and an encoding step of transforming the content into which the forensic mark has been inserted into the second input and output format necessary for the entropy encoding and entropy-encoding the content transformed into the second input and output format.

### Advantageous Effects

According to the forensic marking apparatus and method of the present disclosure, various processing processes performed between an entropy-decoding member for compressed content and a forensic marking member can be omitted. Alternatively, according to the forensic marking apparatus and method of the present disclosure, various processing processes performed between an entropy-decoding member for forensic-marked content and a forensic marking member can be omitted.

The corresponding processing processes include quantization, a transform, motion compensation, intra/inter prediction, etc. and may require a lot of a processing time. According to the present disclosure, a total time taken to insert a forensic mark can be significantly reduced because at least some of the corresponding processing processes are excluded.

A code of entropy-decoded content may be directly provided to the forensic marking member due to the exclusion of various processing processes. In this case, it is difficult to insert the code of the entropy-decoded content into the forensic marking member due to a difference between formats. The transform unit and the marking unit may be provided in order to synchronize the code formats.

The transform unit may transform a code format of the entropy-decoded content into a first input and output format which may be input to the forensic marking member. In this case, the transform unit transforms the code format based on a reference. The corresponding reference may be provided by the marking unit.

The marking unit may perform only very some of the various processing processes that need to be performed between the entropy decoding member and the forensic marking member. For example, the various processing processes may include a process of processing multimedia data and a process related to a syntax structure. In this case, the marking unit may obtain a syntax element that forms a syntax structure by performing only the process related to the syntax structure.

After completing the syntax structure using the syntax element, the marking unit may provide the transform unit with a syntax structure corresponding to the reference for the code format transform.

Meanwhile, the present disclosure can process entropy decoding and entropy encoding in parallel using a plurality of GPUs. For example, the present disclosure may split a frame using a time method, and may process the plurality of split tiles in parallel using a plurality of GPUs. A codec processing time including entropy decoding and the entropy encoding can be significantly reduced by the parallel processing.

When one frame is split into a plurality of regions and processed in parallel, it is necessary to merge the split regions into one in a correct sequence or to prevent the split regions from being mixed with another frame. The present disclosure can restore, to one frame, regions split in plural before and after a codec processing process normally using the synchronization part. In this case, the synchronization part may perform synchronize between the frame and the regions using a syntax structure identified by the parsing unit.

Various types of codec processing are possible using a plurality of GPUs because a transform between the original frame and the split regions can be performed normally through the synchronization part.

The forensic coding apparatus and method of the present disclosure enable real-time forensic marking for a large amount of content compressed using the HEVC method. Furthermore, the present disclosure may be applied to various compression methods and compression algorithms using a single codec in addition to the HEVC method.

### BRIEF DESCRIPTION OF THE DRAWINGS

FIG. 1 is a schematic diagram illustrating a forensic marking system of the present disclosure.

FIG. 2 is a block diagram illustrating a forensic marking apparatus of the present disclosure.

FIG. 3 is a schematic diagram illustrating an operation of a parsing unit.

FIG. 4 is a schematic diagram illustrating an operation of the forensic marking apparatus of the present disclosure.

FIG. 5 is a flowchart illustrating a forensic marking method of the present disclosure.

FIG. 6 is a schematic diagram illustrating a frame split into a plurality of regions by a parallel forensic marking apparatus of the present disclosure.

FIG. 7 is a schematic diagram illustrating the parallel forensic marking apparatus of the present disclosure.

FIG. 8 is a diagram illustrating a computing device according to an embodiment of the present disclosure.

### DESCRIPTION OF EXEMPLARY EMBODIMENTS

Hereinafter, embodiments of the present disclosure are described in detail with reference to the accompanying drawings so that a person having ordinary knowledge in the art to which the present disclosure pertains may easily practice the embodiments. However, the present disclosure may be implemented in various different forms and is not limited to the embodiments described herein. Furthermore, in the drawings, in order to clearly describe the present disclosure, a part not related to the description is omitted, and a similar reference numbers is used to refer to a similar part throughout the specification

In this specification, a redundant description of the same component is omitted.

Furthermore, in this specification, when it is described that one component is “connected” or “coupled” to the other component, it should be understood that one component may be directly connected or coupled to the other component, but a third component may exist between the two components. In contrast, in this specification, when it is described that one component is “directly connected” or “directly coupled” to the other component, it should be understood that a third component does not exist between the two components.

Furthermore, terms used in this specification are used to merely describe a specific embodiment and are not intended to restrict the present disclosure.

Furthermore, in this specification, an expression of the singular number may include an expression of the plural number unless clearly defined otherwise in the context.

Furthermore, in the present disclosure, it is to be understood that a term, such as “include” or “have”, is intended to designate that a characteristic, a number, a step, an operation, a component, a part or a combination of them described in the specification is present, and does not exclude the presence or addition possibility of one or more other characteristics, numbers, steps, operations, components, parts, or combinations of them in advance.

Furthermore, in this specification, the term “and/or” includes a combination of a plurality of described items or any one of a plurality of described items. In this specification, “A or B” may include all of “A”, “B”, or “A and B.”

Furthermore, in this specification, a detailed description of a known function and construction which may make obscure the gist of the present disclosure will be omitted.

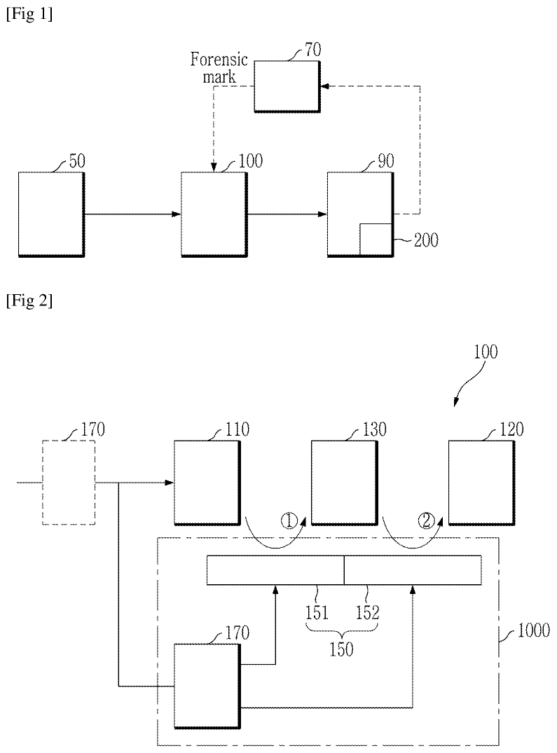

FIG. 1 is a schematic diagram illustrating a forensic marking system of the present disclosure.

The forensic marking system illustrated in FIG. 1 may include a content server 50, a forensic marking server 100, a terminal 90, and a forensic server 70.

The content server 50 may compress and store multimedia content, such as an image and a sound, using a set method.

The terminal 90 may receive content compressed using the set method in a wired and wireless manner by requesting the content from the content server 50. A communication module 200 communicating with the forensic server 70 upon forensic mark-related processing may be provided in the terminal 90.

When content is requested by the terminal 90, the forensic marking server 100 may insert a forensic mark into the content provided to the terminal 90.

The forensic server 70 may obtain user information from the terminal 90, and may generate the forensic mark including the user information. The forensic server 70 may provide the forensic mark to the forensic marking server 100.

In order to insert, into the content, the forensic mark received from the forensic server 70, the forensic marking server 100 may decompress compressed content stored in the content server 50. After inserting the forensic mark into the decompressed content, the forensic marking server 100 may compress the corresponding content again and transmit the compressed content to the terminal 90 in a form, such as a bit stream.

A heavy load may be applied to the forensic server 70 due to a process of decompressing previously compressed content and compressing the decompressed content again, for the marking process of inserting a forensic mark into the content. The insertion of a forensic mark may be practically difficult in a high-compression method aimed at a large amount of content, such as 4k resolution or 8k resolution, due to the heavy load.

FIG. 2 is a block diagram illustrating a forensic marking apparatus of the present disclosure. The forensic marking apparatus illustrated in FIG. 2 may correspond to the forensic marking server 100 of FIG. 1.

The forensic marking apparatus may include a first unit 110, a marking unit 130, a second unit 120, and a transform unit 150.

The first unit 110 may decode content compressed using a set method. The decoding of the content may solely include entropy decoding or may include a first processing process, such as inverse quantization, in addition to the entropy decoding.

Content may be compressed or decompressed in various manners, such as MPEG, high efficiency video codec (HEVC, H.265), and VP9. The content compressed using the set method may be decompressed by the decoding performed in the first unit 110.

The marking unit 130 may insert a forensic mark into the content decoded by the first unit 110. The forensic mark may include information on a seller, a copyright proprietor, or a buyer of the content.

Content requested by the terminal 90 may be a compression copy compressed using a set method. In order to insert the forensic mark, a corresponding compression copy may be in a state in which the compression copy has been decompressed by the first unit 110.

The second unit 120 may encode the content into which the forensic mark has been inserted. The encoding of the content solely includes an entropy encoding process, and may include a second processing process, such as quantization, in addition to the entropy encoding.

The content whose compression has been decompressed by the encoding task of the second unit 120 and into which the forensic mark has been inserted may be changed into the original compression copy format requested by the terminal 90. If the first unit 110 is an input stage of the forensic marking apparatus and the second unit 120 is an output stage of the forensic marking apparatus, a compression copy of content looks like that it is externally input and output. The compression copy output by the forensic marking apparatus may have a state in which the forensic mark has been inserted into the compression copy unlike the existing compression copy. Content input to the first unit 110 in the state in which the content has been compressed using a set method is hereinafter defined as a first compression copy. Furthermore, content compressed and output by the second unit 120 is defined as a second compression copy. The second compression copy may be content in which a forensic mark has been inserted into the first compression copy.

A high-speed member 1000 may be used to reduce the decoding processing time of the first unit 110 or to reduce the encoding processing time of the second unit 120.

The high-speed member 1000 may include the transform unit 150 and a parsing unit 170. The parsing unit 170 may be positioned in front of the first unit or may be connected to the first unit in parallel.

The transform unit 150 may synchronize a first input and output format between the first unit 110 and the marking unit 130. Alternatively, the transform unit 150 may synchronize a second input and output format between the second unit 120 and the marking unit 130.

In order to decompress content compressed using a setting method or a setting codec, entropy decoding and an additional post-processing process may be performed.

For example, in the case of the HEVC method, inverse quantization, inverse transform, inverse motion compensation, and inverse intra/inter prediction tasks may be sequentially performed after entropy decoding. In this case, the marking unit 130 may be formed to receive a code output through the inverse intra/inter prediction task.

The marking unit 130 configured to receive a code output through the inverse intra/inter prediction task cannot receive a code output through any one of entropy decoding, an inverse transform, and inverse motion compensation.

The transform unit 150 of FIG. 2 may synchronize the first input and output format between the first unit 110 and the marking unit 130. For example, the transform unit 150 may transform a format of a code, output through the entropy decoding process, into the first input and output format which may be received by the marking unit 130. For example, the transform unit 150 may transform a format of a code, output through the inverse transform process, into the first input and output format. According to the transform unit 150, a code output through entropy decoding, a code output through an inverse transform, and a code output through inverse motion compensation may be directly input to the marking unit 130 without the intervention of inverse intra/inter prediction in a stage right before the marking unit 130.

If a code output through the entropy decoding process is transformed into the first input and output format by the transform unit 150 and directly input to the marking unit 130, first means for performing inverse quantization, an inverse transform, inverse motion compensation, and inverse intra/inter prediction does not need to be provided in the first unit 110. The corresponding first means may be essentially necessary for the normal playback of previously compressed content. However, the forensic marking apparatus of the present disclosure has an object of inserting a forensic mark into content without a need to play the content back. Accordingly, the corresponding first means may be excluded without a problem. According to the forensic marking apparatus equipped with the transform unit 150, even in the state in which the separate first means has been extremely excluded, a forensic mark may be inserted into previously compressed content.

The first unit 110 may be solely provided with decoding parts 111, 112, 113, and 114 for entropy decoding content. Alternatively, the first unit 110 may be provided with some first means among a plurality of pieces of means for first processing content along with the decoding part.

The second unit 120 may be solely provided with encoding parts 121, 122, 123, and 124 for entropy encoding content into which a forensic mark has been inserted. Alternatively, the second unit 120 may be provided with some second means among a plurality of pieces of means for second processing content into which a forensic mark has been inserted along with the encoding part.

The transform unit 150 may transform an output code of the decoding part or the first means into a first format \textcircled{1} which may be input to the marking unit 130. Alternatively, the transform unit 150 may transform an output code of the marking unit 130 or the second means into a second format \textcircled{2} which may be input to the encoding part.

The marking unit 130 may be formed to receive the code having the first format \textcircled{1} from a first post-processing member that post-processes the content entropy-decoded by the first unit 110.

The second unit 120 may be formed to receive the code having the second format \textcircled{2} from a second post-processing member that post-processes the content into which the forensic mark has been inserted by the marking unit 130.

The transform unit 150 may transform the code, output by the first unit 110, into the code having the first format \textcircled{1}, and may directly provide the code to the marking unit 130. Alternatively, the transform unit 150 may transform the code, output by the marking unit 130, into the code having the second format \textcircled{2}, and may directly provide the code to the second unit 120. According to the present embodiment, various first processing means which need to be present between the first unit 110 and the marking unit 130 may be excluded. Alternatively, various second processing means which need to be present between the marking unit 130 and the second unit 120 may be excluded.

The marking unit 130 may be formed to receive the code having the first format \textcircled{1} output through the first processing process performed along with entropy decoding. According to the present embodiment, the marking unit 130 may have a versatile property which may be applied to other forensic marking devices.

The first processing process may include at least one of inverse quantization, an inverse transform, inverse motion compensation, and inverse intra/inter prediction. The first processing process may be performed by one or more first processing means.

The transform unit 150 may be provided with a first transform part 151 that transforms a code, output by the decoding part, into the code having the first format \textcircled{1} and provides the code to the marking unit 130.

The second unit 120 may be formed to receive the code having the second format \textcircled{2} output through the second processing process performed after the forensic mark is inserted.

The second processing process may include at least one of intra/inter prediction, motion compensation, a transform, and quantization. The second processing process may be performed by one or more second processing means.

The transform unit 150 may be provided with a second transform part 152 that transform the code, output by the marking unit 130, into the code having the second format \textcircled{2} and provides the code to the encoding part.

In order to synchronize the first input and output format or synchronize the second input and output format, the transform unit 150 may use a transform algorithm or a transform routine. In this case, the transform algorithm or the transform routine may be different for each frame. In an environment in which the transform algorithm, etc. is not fixed and is changed every hour, the parsing unit 170 for establishing the transform algorithm in real time may be provided.

The parsing unit 170 may identify the first input and output format or the second input and output format and provide the format to the transform unit 150.

The parsing unit 170 may identify the first input and output format while performing pre-decoding for decompressing content compressed using a set method. Alternatively, the parsing unit 170 may identify the second input and output format while compressing content, decompressed through pre-decoding, using a set method.

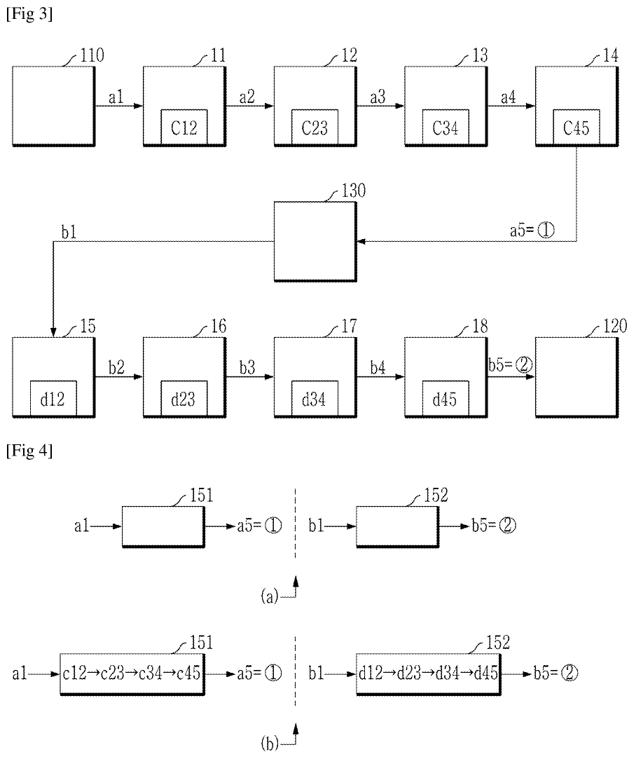

The parsing unit 170 may previously perform actual decoding or actual encoding between content compressed using a set method and content of a playback level. To decode content up to a playback level may mean that all processing processes actually necessary for playback are performed. However, if all actual decoding and actual encoding are performed without omission, the processing time of the parsing unit 170 may be consumed as much as time in a comparison embodiment disclosed in FIG. 3.

In order to improve the processing time, the parsing unit 170 may extract a syntax element that forms a syntax structure for each process of actual decoding or actual encoding or may extract a transform code whose code format is transformed. In this case, a processing process for an image or a sound itself may be excluded.

The parsing unit 170 may provide the syntax element or the transform code to the transform unit 150. The transform unit 150 may synchronize the first input and output format or the second input and output format using the syntax element or the transform code.

FIG. 3 is a schematic diagram illustrating an operation of the parsing unit 170. In FIG. 3, an operation of the parsing unit 170 is described by taking a comparison embodiment as an example. In FIG. 3, if the parsing unit 170 is excluded, the comparison embodiment may be obtained.

When a first compression copy is input, the first unit 110 may entropy-decode the first compression copy. The results of the entropy decoding may be output in an (a1)-th format. A result value of the entropy decoding may sequentially pass through inverse quantization means 11, inverse transform means 12, inverse motion compensation means 13, and inverse intra/inter prediction means 14.

The inverse quantization means may receive a code having the (a1)-th format, and may perform inverse quantization, in other words, may convert digital information into analog information. The results of the inverse quantization may be output in an (a2)-th format. The parsing unit 170 may divide the inverse quantization process into an inverse quantization-inherent process and a format transform process. Through the extraction and analysis of the format transform process, an algorithm or transform code c12 for transforming the code having the (a1)-th format into a code having the (a2)-th format may be obtained.

The inverse transform means may receive the code having the (a2)-th format, and may perform an inverse transform, in other words, a frequency inverse transform. The results of the inverse transform may be output in an (a3)-th format. The parsing unit 170 may divide the inverse transform process into an inverse transform-inherent process and a format transform process. Through the extraction and analysis of the format transform process, an algorithm or transform code c23 for transforming the code having the (a2)-th format into a code having the (a3)-th format may be obtained.

The inverse motion compensation means may receive the code having the (a3)-th format, and may perform inverse motion compensation. The results of the inverse motion compensation may be output in an (a4)-th format. The parsing unit 170 may divide the inverse motion compensation process into an inverse motion compensation-inherent process and a format transform process. Through the extraction and analysis of the format transform process, an algorithm or transform code c34 for transforming the code having the (a3)-th format into a code having the (a4)-th format may be obtained.

The inverse intra/inter prediction means may receive the code having the (a4)-th format, and may perform inverse intra/inter prediction. The results of the inverse intra/inter prediction may be output in an (a5)-th format. The parsing unit 170 may divide the inverse intra/inter prediction process into an inverse intra/inter prediction-inherent process and a format transform process. Through the extraction and analysis of the format transform process, an algorithm or transform code c45 for transforming the code having the (a4)-th format into a code having the (a5)-th format may be obtained.

The (a5)-th format may correspond to the first format \textcircled{1} which may be received by the marking unit 130.

The content into which the forensic mark has been inserted by the marking unit 130 may be output in a (b1)-th format. The content into which the forensic mark has been inserted may sequentially pass through intra/inter prediction means 15, motion compensation means 16, transform means 17, and quantization means 18.

The intra/inter prediction means may receive the code having the (b1)-th format, and may perform intra/inter prediction. The results of the intra/inter prediction may be output in a (b2)-th format. The parsing unit 170 may divide the intra/inter prediction process into an intra/inter prediction-inherent process and a format transform process. Through the extraction and analysis of the format transform process, an algorithm or transform code d12 for transforming the code having the (b1)-th format into a code having the (b2)-th format may be obtained.

The motion compensation means may receive the code having the (b2)-th format, and may perform motion compensation. The results of the motion compensation may be output in a (b3)-th format. The parsing unit 170 may divide the motion compensation process into a motion compensation-inherent process and a format transform process. Through the extraction and analysis of the format transform process, an algorithm or transform code d23 for transforming the code having the (b2)-th format into a code having the (b3)-th format may be obtained.

The transform means may receive the code having the (b3)-th format, and may perform a frequency transform. The results of the transform may be output in a (b4)-th format. The parsing unit 170 may divide the transform process into a transform-inherent process and a format transform process. Through the extraction and analysis of the format transform process, an algorithm or transform code d34 for transforming the code having the (b3)-th format into the (b4)-th format may be obtained.

The quantization means may receive the code having the (b4)-th format and perform quantization. The results of the quantization may be output in a (b5)-th format. The parsing unit 170 may divide the quantization process into a quantization-inherent process and a format transform process. Through the extraction and analysis of the format transform process, an algorithm or transform code d45 for transforming the code having the (b4)-th format into a code having the (b5)-th format may be obtained.

The (b5)-th format may correspond to the second format \textcircled{2} which may be received by the encoding part of the second unit 120.

In the case of the comparison embodiment, in order to insert a forensic mark, a lot of time may be taken because the means except the parsing unit 170 needs to be sequentially driven.

FIG. 4 is a schematic diagram illustrating an operation of the forensic marking apparatus of the present disclosure.

The parsing unit 170 may pre-decode content compressed using a set method or pre-encode pre-decoded content.

The parsing unit 170 may perform only some processes of obtaining a syntax element or a transform code necessary to identify only the first input and output format among pre-decoding processes. Alternatively, the parsing unit 170 may perform only some processes of obtaining a syntax element or a transform code necessary to identify only the second input and output format among the pre-decoding processes.

For example, the parsing unit 170 may perform only a format transform process by thoroughly excluding the inverse quantization-inherent process, the inverse transform-inherent process, the inverse motion compensation-inherent process, and the inverse intra/inter prediction-inherent process described with reference to FIG. 3.

The format transform process has a very shorter processing time than the first processing- or second processing-inherent process. Accordingly, the time taken for a pre-decoding process or pre-encoding process performed by the parsing unit 170 is also short.

The parsing unit 170 may obtain transform codes c12, c23, c34, c45, d12, d23, d34, and d45 by performing the format transform process, and may generate a transform code for synchronizing the first input and output format or the second input and output format.

The parsing unit 170 may primarily decode content compressed using a set method. In this case, the first unit 110 may secondarily decode content compressed using a set method.

In the primary decoding, only an operation of extracting a syntax element necessary to identify the first input and output format in each decoding process defined in the set method may be performed. In this case, the operation of extracting a syntax element may indicate a format transform process.

In the secondary decoding, only entropy decoding provided by the codec of the set method in all of decoding processes defined in the set method is performed, and the remaining merge decoding process may be omitted.

The results of the secondary decoding may be synchronized by the first input and output format and directly output to the marking unit 130.

FIG. 4(a) may indicate the state in which the first input and output format is synchronized or the second input and output format is synchronized using a transform code which is fixed and input or generated by machine learning.

FIG. 4(b) may indicate the state in which all transform codes are prepared by collecting only the corresponding transform codes in accordance with a transform code varying in real time. Each transform code or all of the transform codes may also be obtained by identifying a syntax structure.

When the transform codes c12, c23, c34, and c45 identified by the parsing unit 170 are sequentially disposed, the first transform part 151 capable of synchronizing the first input and output format may be formed.

When the transform codes d12, d23, d34, and d45 identified by the parsing unit 170 are sequentially disposed, the second transform part 152 capable of synchronizing the second input and output format may be formed.

In the case of a method of compressing content using a single codec, the parsing unit 170 may not perform the primary encoding process on the primary-decoded content, and may identify the second input and output format by analyzing a syntax structure generated using a syntax element.

Content into which a forensic mark has been inserted may be synchronized by the second input and output format and directly entropy-encoded. In other words, in the case of content compressed using a single codec method, if the first transform part 151 is inversely configured, the second transform part 152 may be obtained without any change. Accordingly, if a single codec has been applied, the first encoding process is excluded, and the first decoding process has only to be performed.

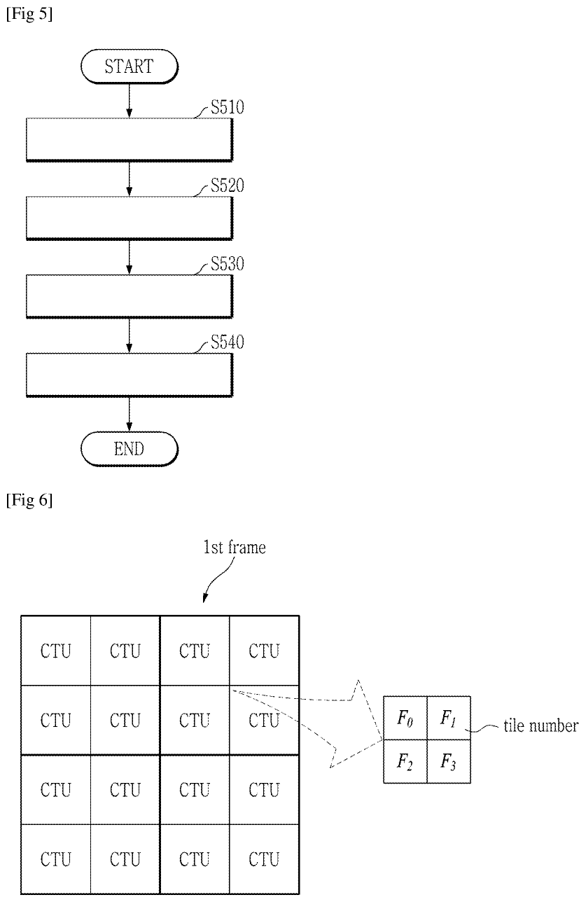

FIG. 5 is a flowchart illustrating a forensic marking method of the present disclosure.

The forensic marking method of the present disclosure may include a parsing step S510, a decoding step S520, a marking step S530, and an encoding step S540. The steps may be performed by the forensic marking apparatus illustrated in FIG. 1

The parsing step S510 may identify the first input and output format between entropy decoding and an operation of inserting a forensic mark and the second input and output format between the insertion operation and entropy encoding by pre-decoding content compressed using a set method.

The decoding step S520 may entropy-decode the content, and may transform the entropy-decoded content according to the first input and output format.

The marking step S530 may receive the content transformed into the first input and output format, and may insert a forensic mark.

The encoding step S540 may transform the content into which the forensic mark has been inserted into the second input and output format necessary for entropy encoding, and may entropy-encode the content transformed into the second input and output format.

According to the present disclosure, a separate first processing process between the decoding step and the marking step may be excluded. Furthermore, a separate second processing process between the marking step and the encoding step may be excluded. The speed of forensic marking can be significantly improved by excluding the first processing process and the second processing process. Through the improvement of the speed, a forensic mark can be inserted into multimedia content having a playback ability of 8K resolution 60 frame/seconds or more in real time.

In order to further improve the insertion speed of a forensic mark, a parallel processing method may be introduced.

For example, in order to smoothly perform forensic marking on 8K 60 fps content, parallel processing using a graphic processor unit (GPU) may be considered. In order to perform a forensic marking service for streaming, the content server 50 may store content having a standard proposed by a compression technology using a set method. For example, in the HEVC standard, upon first encoding for the original content, it is better to encode the content in parallel. The reason for this is that if the content is not initially encoded in parallel, parallel processing becomes difficult because coding tree units (CTUs) having different conditions for each image have an association. Accordingly, the content server 50 may register the original raw content in a content registration procedure, may receive a CTU size and a tile size as parameters, and may encode the content into the tile.

The content that has been processed in parallel and stored in the content server 50 may be input to the parallel forensic marking apparatus of the present disclosure.

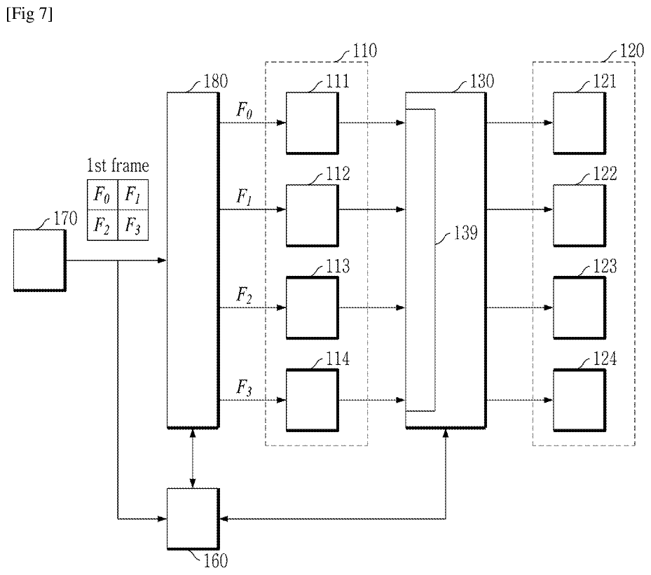

FIG. 6 is a schematic diagram illustrating a frame split into a plurality of regions by a parallel forensic marking apparatus of the present disclosure. FIG. 7 is a schematic diagram illustrating the parallel forensic marking apparatus of the present disclosure. The parallel forensic marking apparatus illustrated in FIG. 7 may correspond to the forensic marking server 100 of FIG. 1.

The parallel forensic marking apparatus of the present disclosure may include a split part 180, a plurality of decoding parts 111, 112, 113, and 114, and a synchronization part 160.

The split part 180 may split one frame of content, compressed using a set method, into a plurality of regions.

The plurality of decoding parts may perform entropy decoding on the split regions assigned thereto, respectively.

The synchronization part 160 may complete the frame by synchronizing the regions input to and output from the plurality of decoding parts.

The content compressed using the setting method may be content encoded from raw content using a time method using a coding tree unit (CTU) size and a tile size as parameters. The split part 180 may split the frame into the plurality of regions according to a tile method. The plurality of decoding parts may independently entropy-decode the split regions.

For example, as in FIG. 6, a 1^{st} frame may be split into four regions by the split part 180. The split part 180 may assign different tile numbers F0, F1, F2, and F3 to the split regions. Each tile may include a plurality of CTUs. In the case of the HEVC method, the size of a tile and the size of a CTU may be fixed, but a CU included in the CTU may be different for each CTU or tile.

When content is compressed using the high efficiency video codec (HEVC) method, the processing speed of each decoding part that entropy-decodes each region may be different due to a difference between coding units (CU) included in each region. Due to a difference between the processing speeds, although the plurality of tiles F0, F1, F2, F3 split from the one 1^{st} frame are simultaneously input to the decoding parts, timing at which the tile is output from the decoding part may be different.

For example, the tile F0 may be input to the first decoding part 111. Tile F1 may be input to the second decoding part 112. The tile F2 may be input to the third decoding part 113. The tile F3 may be input to the fourth decoding part 114. In this case, although the input timing is the same, timing at which the tile is output from each decoding part may be different.

The synchronization part 160 may assemble one frame by matching regions, split in plural and entropy-decoded, using tile numbers. For example, a storage part 139 for storing the regions output from the respective decoding parts at different timing may be provided.

The synchronization part 160 may complete the frame by collecting the regions, stored in the storage part 139, into one.

Each region of a specific frame may be output from each decoding part at different timing due to a difference between CUs. In the state in which entropy encoding for a region of a specific frame is performed in another decoding part, if a specific decoding part becomes an idle state, the synchronization part 160 may input some region of a next frame into the specific decoding part in the idle state.

For example, if the first decoding part has first processed the tile F1, the first decoding part may become the idle state. In this case, the synchronization part 160 may input a tile of a next frame into the first decoding part. For processing speed balancing of all of the decoding parts, it is better to input, to the first decoding part, a tile predicted to consume the most processing time in a next frame.

The parsing unit 170 may be used to predict the processing time of each tile or equally maintain the processing speed and processing time of each decoding part.

The parsing unit 170 may identify a syntax structure through a pre-decoding process.

The synchronization part 160 may synchronize the plurality of regions using the syntax structure.

The parsing unit 170 may divide pre-decoding into multimedia data processing and syntax-related processing. The multimedia data processing may include the aforementioned inverse quantization-inherent process, inverse transform-inherent process, inverse motion compensation-inherent process, and inverse intra/inter prediction-inherent process. The syntax-related processing may include the aforementioned format transform process.

The parsing unit 170 may obtain a syntax element necessary to identify the syntax structure by performing only the syntax-related processing to the exclusion of the multimedia data processing.

The synchronization part 160 that has received the syntax element or the syntax structure from the parsing unit 170 may predict a decoding time for each region with respect to the frame prior to the decoding. The synchronization part 160 may assign a split region of each frame to each decoding part in a way to minimize a difference between total task times of the decoding parts for the entire content using the prediction times.

When the marking unit 130 for inserting a forensic mark into content is provided, a format of a code output by the decoding part may be different from the first input and output format necessary for the marking unit 130.

The transform unit 150 for transforming an output code of the decoding part into the first input and output format using the syntax structure and providing the marking unit 130 with the output code transformed into the first input and output format may be provided.

The split part 180 and the synchronization part 160 may be formed in the central processing unit (CPU) of a computer device. The decoding part may be formed in the graphics processing unit (GPU) of the computer device.

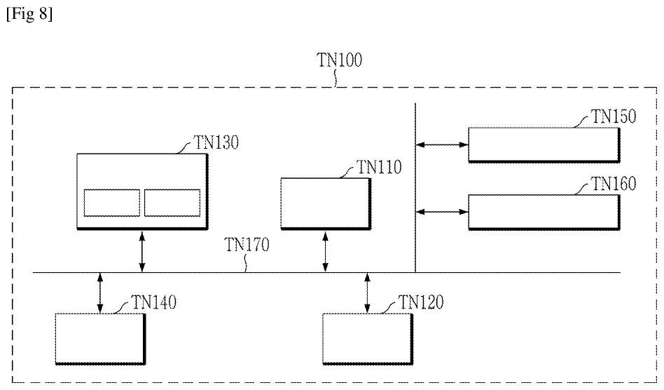

FIG. 8 is a diagram illustrating a computing device according to an embodiment of the present disclosure. The computing device TN100 of FIG. 8 may be an apparatus (e.g., the forensic marking apparatus and the parallel forensic marking apparatus) described in the present disclosure.

In the embodiment of FIG. 8, the computing device TN100 may include at least one processor TN110, a transmission and reception device TN120, and a memory TN130. Furthermore, the computing device TN100 may further include a storage device TN140, an input interface device TN150, an output interface device TN160, etc. The components included in the computing device TN100 are connected by a bus TN170, and may perform communication with each other.

The processor TN110 may execute a program command stored in at least one of the memory TN130 and the storage device TN140. The processor TN110 may mean a central processing unit (CPU), a graphics processing unit (GPU), or a dedicated processor for performing the methods according to an embodiment of the present disclosure. The processor TN110 may be configured to implement the procedures, functions, and methods described in relation to the embodiments of the present disclosure. The processor TN110 may control the components of the computing device TN100.

Each of the memory TN130 and the storage device TN140 may store various types of information related to an operation of the processor TN110. Each of the memory TN130 and the storage device TN140 may be configured as at least one of a volatile storage medium and a non-volatile storage medium. For example, the memory TN130 may be configured as at least one of a read only memory (ROM) and a random access memory (RAM).

The transmission and reception device TN120 may transmit or receive a wired signal or a radio signal. The transmission and reception device TN120 is connected to a network, and may perform communication.

Meanwhile, the embodiments of the present disclosure are not implemented by only the method and apparatus described so far, but may be implemented through a program that realizes a function corresponding to a construction according to an embodiment of the present disclosure or a recording medium on which the program is recorded. Such an implementation may be evident to those skilled in the art to which the present disclosure pertains from the embodiments.

The exemplary embodiments of the present disclosure have been described in detail, but the scope of rights of the present disclosure is not limited thereto. The scope of rights of the present disclosure also includes a variety of modifications and changes which are defined in the appended claims and will be performed by those skilled in the art using the basic concept of the present disclosure.

What is claimed is:

1. A forensic marking apparatus comprising:
a split part configured to split one frame of content, compressed using a setting method, into a plurality of regions;
a plurality of decoding parts configured to have the split regions assigned thereto, respectively, and to perform entropy-decode the split regions; and
a synchronization part configured to complete the frame by synchronizing the regions input to and output from the plurality of decoding parts.

2. The forensic marking apparatus of claim 1, wherein:
the content compressed using the set method encoded from raw content using a time method using a coding tree unit (CTU) size and a tile size as parameters,
the split part splits the frame into the plurality of regions using the tile method, and
the plurality of decoding parts independently entropy-decodes the split regions.

3. The forensic marking apparatus of claim 1, wherein:
the set method is a high efficiency video codec (HEVC),
each decoding part entropy-decoding each region has a different processing speed due to a difference between coding units (CUs) included in each region,
a storage part for storing the regions output from the decoding parts at different timing is provided, and
the synchronization part completes the frame by collecting the regions stored in the storage part into one.

4. The forensic marking apparatus of claim 1, wherein:
a different tile number is assigned to each region, and
the synchronization part assembles the one frame by matching the regions, split in plural and entropy-decoded, using the tile numbers.

5. The forensic marking apparatus of claim 1, wherein:
each region of a specific frame is output from each decoding part at different timing, and
in a state in which entropy decoding is performed on the region of the specific frame in another decoding part, when a specific decoding part becomes an idle state, the synchronization part inputs some regions of a next frame into the specific decoding part.

6. The forensic marking apparatus of claim 1, wherein:
a parsing unit configured to identify a syntax structure through a pre-decoding process is provided, and
the synchronization part synchronizes the plurality of regions using the syntax structure.

7. The forensic marking apparatus of claim 6, wherein:
the parsing unit divides the pre-decoding into multimedia data processing and syntax-related processing, and
the parsing unit obtains a syntax element necessary to identify the syntax structure by performing only the syntax-related processing to an exclusion of the multimedia data processing.

8. The forensic marking apparatus of claim 6, wherein:
a marking unit configured to insert a forensic mark into the content is provided,
a code output by the decoding part is different from a first input and output format necessary for the marking unit, and
a transform unit configured to transform the output code of the decoding part into the first input and output format using the syntax structure and to provide the marking unit with the output code transformed into the first input and output format is provided.

9. The forensic marking apparatus of claim 1, wherein:
the split part and the synchronization part are formed in a central processing unit (CPU) of a computer device, and
the decoding part is formed in a graphics processing unit (GPU) of the computer device.
